(19) United States
(12) Patent Application Publication
(10) Pub. No.: US 2009/0307200 A1
(43) Pub. Date: Dec. 10, 2009

(54) System and Method For Providing Suppression of Zero, Null, Overflow, and Divide by Zero Values in Sparse Query Results

(76) Inventors: Liviu IGNAT, Nepean (CA); Soufiane AZIZI, Ottawa (CA); David CUSHING, Osgoode (CA)

Correspondence Address: Gowling Lafleur Henderson LLP, 160 Elgin Street, Suite 2600, Ottawa, Ontario, ON, K1P1C3, CA

(21) Appl. No.: 12/477,627

(22) Filed: Jun. 3, 2009

Related U.S. Application Data
(60) Provisional application No. 61/059,390, filed on Jun. 6, 2008.

(51) Int. Cl. G06F 17/30; G06F 15/16

(52) U.S. Cl. 707/4; 707/E17.014; 707/10; 709/203

(57) ABSTRACT

A suppression provider comprises a query preparation unit and a query execution unit. The query preparation unit analyzes a request from a client for data to obtain suppression criteria from an edge suppression specification in the request, and saving the suppression criteria in a query plan generated. The query execution unit receives execution result data including values, each associated with one or more edge values, determines if each value is to be suppressed based on the suppression criteria, and identifies one or more edge values to be suppressed when an edge value has only values that are determined to be suppressed. Thus, the suppression provider suppresses values and/or edge values identified to be suppressed in a resultant report.

### CROSS-REFERENCE TO RELATED APPLICATION

This application claims the benefit of U.S. Provisional Application No. 61/059,390, filed Jun. 6, 2008.

### FIELD OF THE INVENTION

The present invention relates to a system and method for providing suppression of zero, null, overflow, and divide by zero values in sparse query results.

### BACKGROUND OF THE INVENTION

Many organizations use data stores for storing business data, such as financial data and operational data. In order to assist business users to examine their data, various data analyzing applications are proposed. Those data analyzing applications provide various views or reports of data to users. The data analyzing applications have query engines that access the underlying data stores to obtain desired data. Resultant reports with the desired data are often used as Business Intelligence reports such that report consumers can analyze various Business Intelligence of their organization. Some data analyzing applications have Online Analytical Processing (OLAP) engines to provide multidimensional views of data.

A Business Intelligence report consumer often faces a problem when the underlying queries in Structured Query Language (SQL) and/or Multi Dimensional Expression (MDX) for his/her report return data with a large number of zero values. In this case, the report consumer often likes to have access to a quick filtering method that removes the zero values from his/her report. However, Business Intelligence users needed to use complex filtering expressions in order to deal with this data sparcity problem.

It is therefore desirable to provide an easy filtering of unwanted values from in sparse query results.

### SUMMARY OF THE INVENTION

It is an object of the invention to provide an improved system and method for providing suppression of unwanted values, e.g., zero, null, overflow, and divide by aero, in sparse reports of query results that obviates or mitigates at least one of the disadvantages of existing systems.

The invention uses a suppression provider that saves suppression criteria in a query plan, and suppresses values and/or edge values based on the suppression criteria during the execution of the query plan.

In accordance with an aspect of the present invention, there is provided a suppression provider for suppressing unwanted values in reports. The suppression provider comprises a query preparation unit and a query execution unit. The query preparation unit is provided for analyzing a request from a client for data from one or more underlying data sources to obtain suppression criteria from an edge suppression specification in the request, and creating a query plan and saving the suppression criteria in the query plan. The query execution unit is provided for receiving execution result data including values, each associated with one or more edge values, determining if each value is to be suppressed based on the suppression criteria, and identifying one or more edge values to be suppressed when an edge value has only values that are determined to be suppressed such that values and/or edge values identified to be suppressed are suppressed in a resultant report.

In accordance with another aspect of the present invention, there is provided a method of suppressing unwanted values from a report. The method comprises receiving a request from a client for data from one or more data sources; obtain suppression criteria from an edge suppression specification in the request; generating a query plan and saving the suppression criteria in the query plan; receiving execution result data including values, each value being associated with one or more edge values; determining if each value is to be suppressed based on the suppression criteria; identifying one or more edge values to be suppressed when an edge value has only values that are determined to be suppressed; and suppressing values and/or edge values identified to be suppressed in a resultant report.

In accordance with another aspect of the present invention, there is provided a computer readable medium storing instructions or statements for use in the execution in a computer of a method of suppressing unwanted values from a report. The method comprises receiving a request from a client for data from one or more data sources; obtain suppression criteria from an edge suppression specification in the request; generating a query plan and saving the suppression criteria in the query plan; receiving execution result data including values, each value being associated with one or more edge values; determining if each value is to be suppressed based on the suppression criteria; identifying one or more edge values to be suppressed when an edge value has only values that are determined to be suppressed; and suppressing values and/or edge values identified to be suppressed in a resultant report.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a block diagram showing a suppression provider in accordance with an embodiment of the present invention;

FIG. 2 is a block diagram showing an example of a query framework system;

FIG. 3 is a diagram showing an example of a query framework system;

FIG. 4 is a diagram showing an embodiment of the suppression provider;

FIG. 5 is an example of an edge specification for a crosstab;

FIG. 6 is an example of an edge specification for a list;

FIG. 7 is an example of a crosstab before suppression;

FIG. 8 is the crosstab after suppression;

FIG. 9 is another example of a crosstab before suppression;

FIG. 10 is the crosstab after suppression;

FIG. 11 is another example of a crosstab before suppression;

FIG. 12 is the crosstab after suppression;

FIG. 13 is an example of a list before suppression;

FIG. 14 is the list after suppression;

FIG. 15 is another example of a list before suppression;

FIG. 16 is the list after suppression;

FIG. 17 is another example of a list before suppression;

FIG. 18 is the list after suppression; and

FIG. 19 is a flowchart showing a method of providing suppression in accordance with an embodiment of the present invention.

### DETAILED DESCRIPTION OF EMBODIMENTS

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

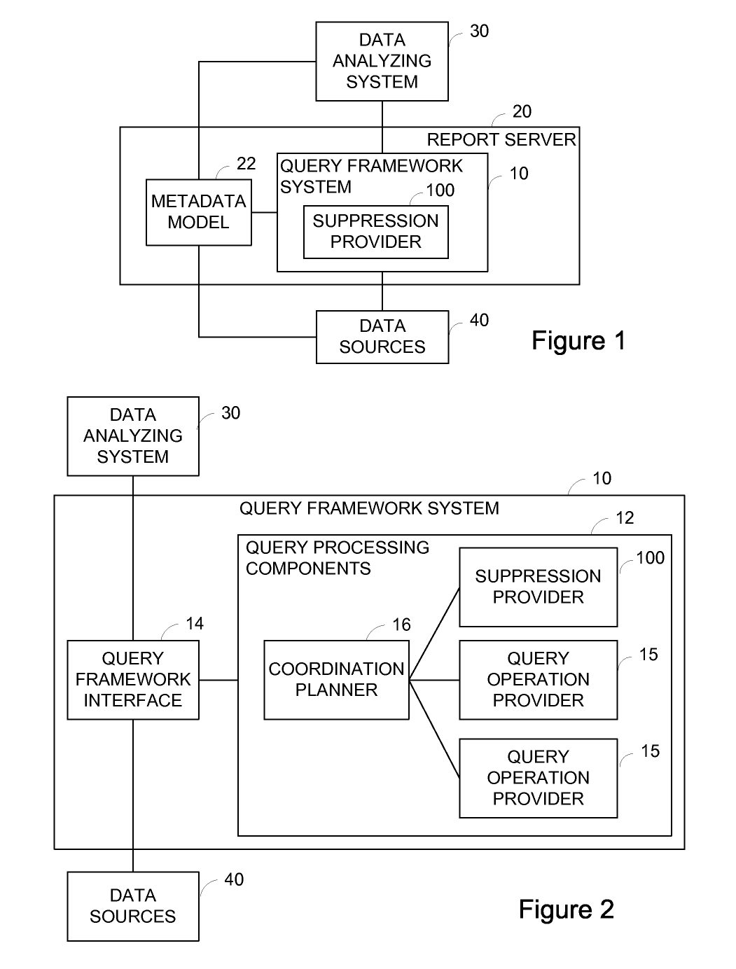

Referring now to FIGS. 1 to 19, embodiments of the present invention are described.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Referring to FIG. 1, a suppression provider 100 in accordance with an embodiment of the application is described. The suppression provider 100 is suitably used in an open system of loosely coupled query processing components. In the embodiment shown in FIG. 1, the suppression provider 100 works as part of a query framework system 10 that is used in a report server 20. The query framework system 10 is provided to receive user requests for data from a data analyzing system 30 and process the received user requests to retrieve requested data from one or more data sources 40 using a metadata model 22. The metadata model 22 contains metadata of the data sources 40 and represents the architecture of the data sources 40. The retrieved data is provided to the data analyzing system 30 for the user to view and analyze it. These systems may be suitably used in server-client environments.

The suppression provider 100 is implemented as a component in the query framework system 10 which is a system of components with different responsibilities: query planners providing the translation of the system query language into the query language of underling system (e.g. SQL, MDX); query transformation providers responsible for preprocessing of the query; and feature adapters responsible for local operations, where any component can be replaced, new components can be added or extracted out the system with the minimum disruption to the system.

When a BI report, ad hoc query, analysis, or visualization is submitted by the interface components against an OLAP or a Relational data source, the suppression provider 100 intercepts the associated BI query if it has an edge suppression specification. The suppression provider 100 plans the query by relying on the associated metadata model, creates a plan of execution. Then, it intercepts the results during execution and locally processes the results from the OLAP or relational planners by filtering zero, null, overflow, and divide by zero values.

Prior to describing the suppression provider 100 further, the query framework system 10 is described. The query framework system 10 intercepts user requests generated by the data analyzing system 30. It processes and executes the user requests to retrieve desired data from the data sources 40. A user request is in a query language that the query analyzing system 30 uses to issue the user request. The user request includes one or more queries.

As shown in FIG. 2, the query framework system 10 has multiple query processing components 12. Query processing components 12 include a set of query operation providers 15 including the suppression provider 100, and a coordination planner 16. Query processing components 12 share a common interface 14 and a common query language of the query framework system 10. Query processing components 12 are pluggable.

Each query operation provider 15 is capable of performing a specific operation on queries, as further exemplified below. In FIG. 2, three query operation providers 15 including the suppression provider 100 are shown for the purpose of illustration. There may be more or fewer query operation providers in the query framework system 10.

The query framework system 10 uses a query framework (QF) query. A QF query plays the role of a query specification that the query operation providers 15 use to communicate with each other and with the coordination planner 16 within the query framework system 10. The QF query definition is an extension of the user request specification defined by the data analyzing system 30. The QF query has one or more query sections or patterns.

The query framework system 10 divides the query processing into two phases: query planning or preparation phase and a query execution phase. The final result of the query planning process phase is a query execution plan, which is executed during the query execution process phase. During the query preparation phase, the coordination planner 16 interacts with query operation providers 15 in order to identify and plan the operations associated with each provider 15, and to determine the sequence of these operations expressed in an execution plan. The coordination planner 16 may use one or more query operation providers 15 during the query preparation phase. During the query execution phase, the coordination planner 16 distributes the query operations to associated query operation providers 15, invoking the query operation providers 15 in accordance with the sequence expressed by the execution plan determined at the preparation phase.

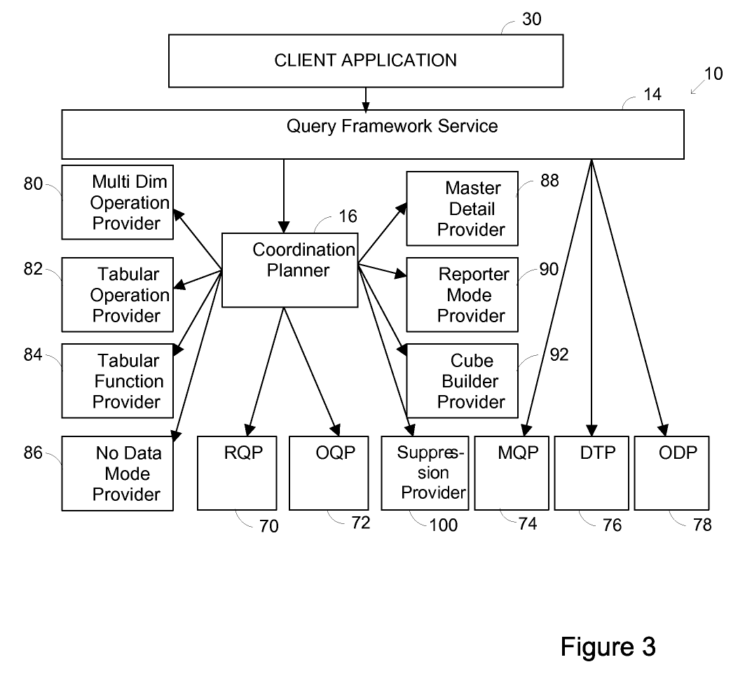

FIG. 3 shows an example of the query framework system 10 receiving user request from data analyzing systems, through client applications 30.

In this example, the query framework system 10 has two having two types of query operation providers 15: planner providers 70-78, 100, and query transformation providers 80-92. The query planner providers replace the QF query representing the received user request with one or more provider queries. Each provider query is executable by an associated query provider, i.e., it has no children query patters and hence do not need input data streams during the execution phase. Planner providers support execution of a provider query without accepting incoming data streams. In this example, the query framework system 10 has relational query planner provider (RQP) 70, OLAP query planner provider (OQP) 72, metadata query provider (MQP) 74, drill through provider (DTP) 76, OLAP data providers (ODP) 78 and suppression provider 100. Query transformation providers are responsible for preprocessing of a QF query for the consumption of the transformed query by other query operation providers. In this example, the query framework system 10 has a multi dimensional operation provider 80, tabular operation provider 82, tabular function provider 84, no data mode provider 86, master detail provider 88, reporter mode provider 90 and cube builder provider 92. In a different embodiment, a different set of query operation providers may be used.

The query framework system 10 facilitates reuse of the planning logic compiling all query operation provider actions in a single execution plan, as further described in United States patent application publication No. US 2006/0294076 A1 published Dec. 28, 2006, which is hereby incorporated by reference.

The suppression provider 100 in accordance with an embodiment of the present invention is now described in details.

The suppression provider 100 provides easy filtering of unwanted values by suppressing those values and/or edge values having those values in sparse reports of query results. Unwanted values may be zero, null, overflow, and/or divide by zero values. An edge value is a value in an edge, e.g., corresponding to a specific row or a specific column in a crosstab. A list has a single edge, which may be represented as a tree of nodes. In a list, an edge value may be also considered as a row in the edge rowset.

By suppressing these unwanted values, the data sparsety problem can be solved, and the resultant reports can be more compact, containing useful data only. It becomes easy to use and analyze the reports.

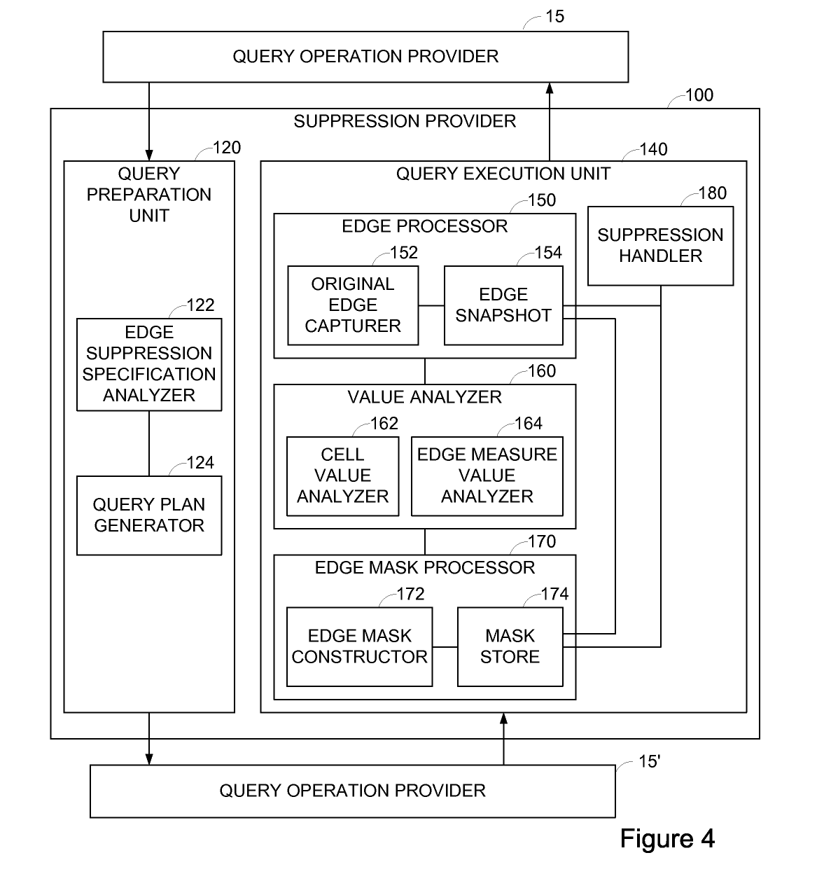

FIG. 4 shows an embodiment of the suppression provider 100. In this embodiment, the suppression provider 100 has a query preparation unit 120 and a query execution unit 140. The query preparation unit 120 has an edge processor 150, a value analyzer 160, an edge mask processor 170, and a suppression handler 180. The edge processor 150 has an original edge capturer 152 and an edge snapshot 154. The value analyzer 160 has a cell value analyzer 162 and an edge measure value analyzer 164. The edge mask processor 170 has an edge mask constructor 172 and a mask store 174.

A data analyzing system issues a user request of a report. The user request includes one or more queries to obtain desired data from one or more underlying data sources and layout information of the data in the report. When a user request is received and translated into a QF query representing the user request, the coordination planner 16 invokes the query operation providers 15 in a specified order to prepare the QF query for execution. During this query preparation phase, each invoked query operation provider 15 receives the QF query from its previous query operation provider and processes a relevant section or pattern of the QF query to generate a provider query containing a query plan, and replaces the relevant pattern of the QF query with the generated provider query. The processed QF query is passed onto the next query operation provider for further planning.

When the suppression provider 100 is invoked, the query preparation unit 120 receives the QF query from the previous query operation provider 15 in the query planning sequence.

In the query preparation unit 120, the edge suppression specification analyzer 122 analyzes the received QF query to see if it contains an edge suppression specification. An edge suppression specification is defined in the user request to specify suppression criteria, including information as to what type(s) of values should be suppressed, and what edge value(s) should be considered for possible suppression, e.g., rows only, columns only or a combination of rows and columns. When the edge suppression specification is found, the edge suppression specification analyzer 122 extracts the suppression criteria. The query plan generator 124 generates a provider query containing a query plan of the suppression provider 100. The query plan generator 124 stores the extracted suppression criteria in the query plan. The QF query partially replaced with the query plan of the suppression provider 100 is passed onto the next query operation provider 15′ in the planning sequence.

During the query execution phase, data is obtained from the underlying data sources. The obtained data includes values, each associated with one or more edge values, depending on the layout information in the user request. Values are cell values in a case of a cross tab, and edge measure values in a case of a list.

When the data is passed onto the suppression provider 100 from the previous query operation provider 15′, the query execution unit 140 receives the obtained data and processes the data based on the query plan of the suppression provider 100 generated by the query preparation unit 120 during the query preparation phase.

In the query execution unit 140, the original edge capturer 152 of the edge processor 150 captures edges information in the received data, and stores it in the edge snapshot 154. The value analyzer 160 analyzes the values of the data based on the suppression criteria stored in the query plan. For a crosstab, the cell value analyzer 162 analyzes each cell value to identify cells having values that meet the suppression criteria. For a list, the edge measure value analyzer 164 analyzes each edge measure value to identify edge measure values having values that meet the suppression criteria. The edge mask constructor 172 of the edge mask processor 170 finds which edge values should be analyzed for possible suppression based on the suppression criteria, e.g., if it should analyze only rows, only columns or both rows and columns in a case of a crosstab. It determines if all cells or edge measure values associated with each edge value are identified as having met the suppression criteria and to be suppressed. When the edge mask constructor 172 determines that a specific edge value meets this condition, it sets a mask to the edge value indicating that this edge value should be suppressed, and stores the mask information in association with the edge value in the mask store 174.

The mask information is used to update the edge snapshot 154.

The suppression handler 180 uses the updated edge information stored in the edge snapshot 154 and the mask information stored in the mask store 174, and passes to the client or next query operation provider 15 only the report values which are not identified to be suppressed. The report values are cell values and edge values in a crosstab, and edge measure values in a list. Thus, the suppression provider 100 can suppress unwanted values and/or edges having all unwanted values in the resultant report.

The operation of the suppression handler 180 is further described using examples of crosstabs and lists. The term “crosstabs” is used below as a short for crosstabs and charts.

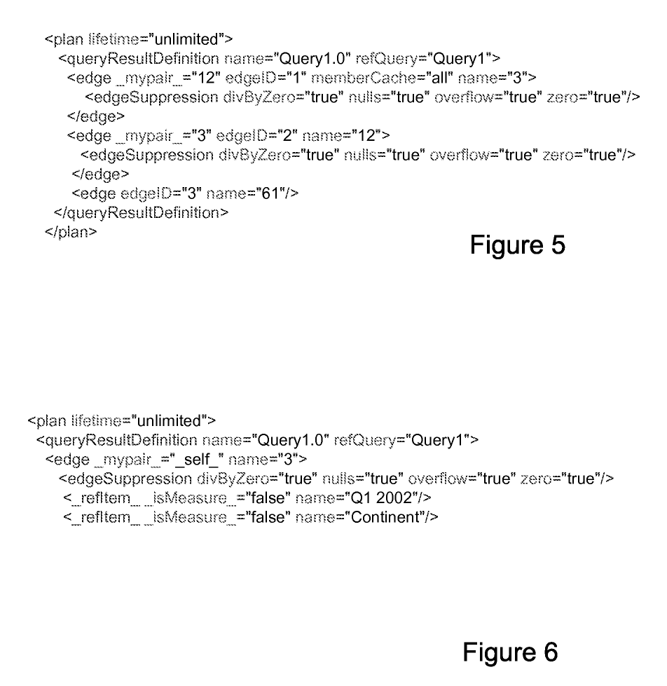

For a crosstab, during the preparation phase, the query preparation unit 120 generates a query plan, which represents a prepared crosstab query result set definition (QRD). The suppression criteria saved in the query plan includes (a) value suppression criteria, i.e., what types of values should be suppressed: e.g., null, overflow, zero, or divide by zero, or any combination thereof; and (b) edge suppression criteria, i.e., which edges should be suppressed: e.g., each rows edge, each columns edge, or a pair edge of corresponding rows and columns. FIG. 5 shows an example of the edge specification that specifying suppression criteria for a cross tab.

For a list, during the preparation phase, the query preparation unit 120 generates a query plan, which represents a prepared list QRD. The suppression criteria saved in the query plan includes (a) value suppression criteria, i.e., what types of values should be suppressed: e.g., null, overflow, zero, or divide by zero, or any combination thereof; and (b) edge suppression criteria, i.e., which data items should be suppressed: e.g., a list identifying each data item referenced in the QRD as being a measure or not. FIG. 6 shows an example of the edge specification that specifying suppression criteria for a list.

An example of the processing logic used by the query preparation unit 120 during the preparation or planning phase is now described. The query preparation unit 120 scans the request. For any multi-edge query result definition (QRD) found in the request, the query preparation unit 120 identifies row/column/cells edges. The query preparation unit 120 identifies all the QRDs having at least one <edge> descendant having an <edgeSupprssion> sub-element as candidates for suppression and collects them. For each of the candidates, the query preparation unit 120 (1) removes the original QRD from its parent element, and (2) creates a provider query. This provider query replaces the QRD's corresponding <query> element and has the following characteristics: it contains a plan having the structure described above; and it is sourced on a query/QRD combination that is a clone of the original one and that has the <edgeSuppression> tags removed.

The query preparation unit 120 do not modify all other QRDs and their corresponding queries. The query preparation unit 120 disregards as candidates for suppression some special-case crosstabs that have no cells, e.g., one-edge crosstabs or two-edged crosstabs with no measure.

Also, for lists, the query preparation unit 120 marks all the referenced data items as measures or non-measures according to their expression and its model references.

Finally, the query preparation unit 120 removes all the <edgeSuppression> tags.

An example of the processing logic used by the query execution unit 140 during the execution phase is now described. The input of the query execution unit 140 is the master dataset, which is called “original dataset”, produced by the next active query operation provider in the planning processing sequence, which is called “the underlying provider”. This is the underlying provider's implementation of the query framework result set API.

The output of the query execution unit 140 is the suppression provider 100 master dataset. This is the suppression provider 100 implementation of the query framework result set API. A set of implementations that allow the client of the ZS functionality, which is called the “client”, to navigate through the original dataset by skipping all the cell rows and/or columns satisfying the suppression criteria and their corresponding edge values in the case of crosstabs.

The information saved in the query plan during the prepare/plan phase is used during the execution phase. To assist in the implementation of these navigational methods, the query execution unit 140 performs the following processing.

For crosstabs, the query execution unit 140 scans the underlying cells set. The query execution unit 140 employs specific logic to pre-determine whether the scanning should be done in a row-major or column-major order. For each edge to be suppressed, the query execution unit 140 constructs a vector of Boolean values, which is called a “mask”. The query execution unit 140 employs negative logic, through which the query execution unit 140 inserts a false (F) entry into the mask if at least one of the values in the cells having the edge coordinate corresponding to the current index in the mask does not satisfy the suppression criteria. The query execution unit 140 inserts a true (T) entry into the mask otherwise.

Next, for each edge, which is internally represented as a tree structure due to the nesting, cross-product-ing and summarization, the query execution unit 140 constructs an internal tree representation of the underlying edge, which is called “edge snapshot”, by fully navigating that underlying edge. The query execution unit 140 stores in the process all the parentage information between the nodes, as well as other additional original information. Then, the query execution unit 140 marks all the nodes in the edge snapshot as T or as F according to the following set of rules, wherein T means that it should be skipped/suppressed, and F means that it should not be skipped/suppressed: all nodes are by default set to T; if a node is a leaf and it corresponds to an edge mask value of F, it is marked as F; and if a node is F, its parent is marked as F.

For lists, the processing logic during the execution is similar to that for the crosstab case. A difference is that the query execution unit 140 constructs an edge snapshot employing the following logic or algorithm which is a non-negative type logic. List edges are conceptually considered as nodes in a list tree. Each row in the list edge rowset, i.e., each node in the list tree, is being marked as “T” if it needs to be suppressed, or as “F” otherwise. By default all the nodes, i.e., rows, are marked as T.

The query execution unit 140 performs two passes:
P1 [up the tree]: Mark each row that does not satisfy the suppression criteria as F. Mark all its ancestors also as F.
P2 [down the tree]: If a row is T, mark all its descendants in the list tree as T. Also, before that, if all its descendants are suppressed, mark it as suppressed.

The query execution unit 140 also performs extra processing: if a row is a footer or header with no corresponding details, suppress it, and its ancestor if any.

For both crosstabs and lists, the query execution unit 140 redirects all the edge and cells client navigation using the data structures having the masks, as described above.

In addition, all the requests from the client regarding the report metadata, which is descriptive information about the edges/cells, e.g., data type, precision and number of columns, are intercepted by the suppression provider 100 and redirected to the underlying provider's corresponding metadata calls, typically after being subject to some preparatory transformations.

The query execution unit 140 uses specific logic to allow the client page-size navigation/rendering, e.g., page down, page up, first page, and last page.

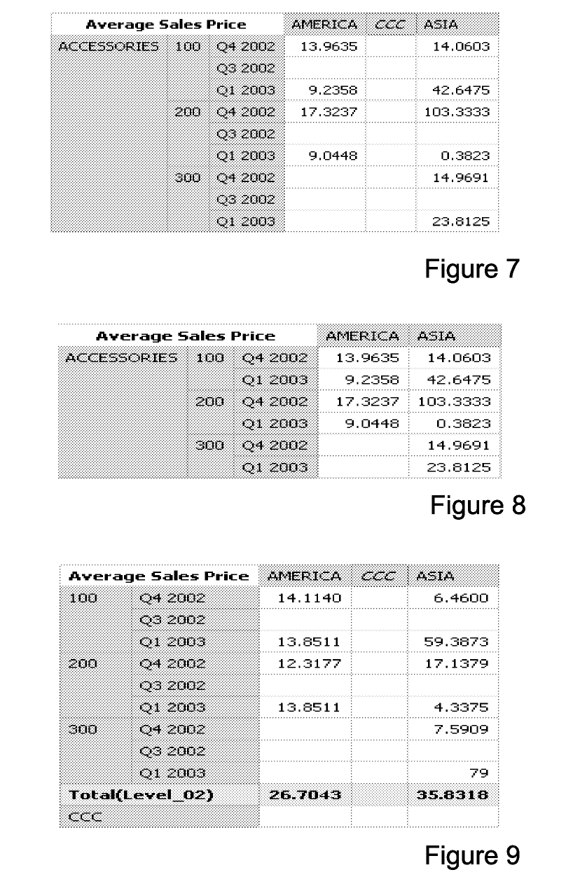

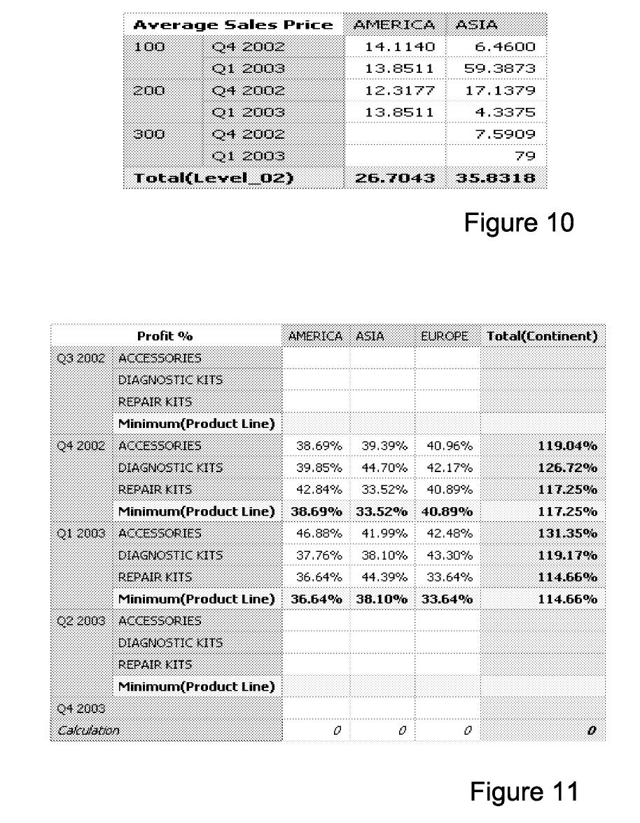

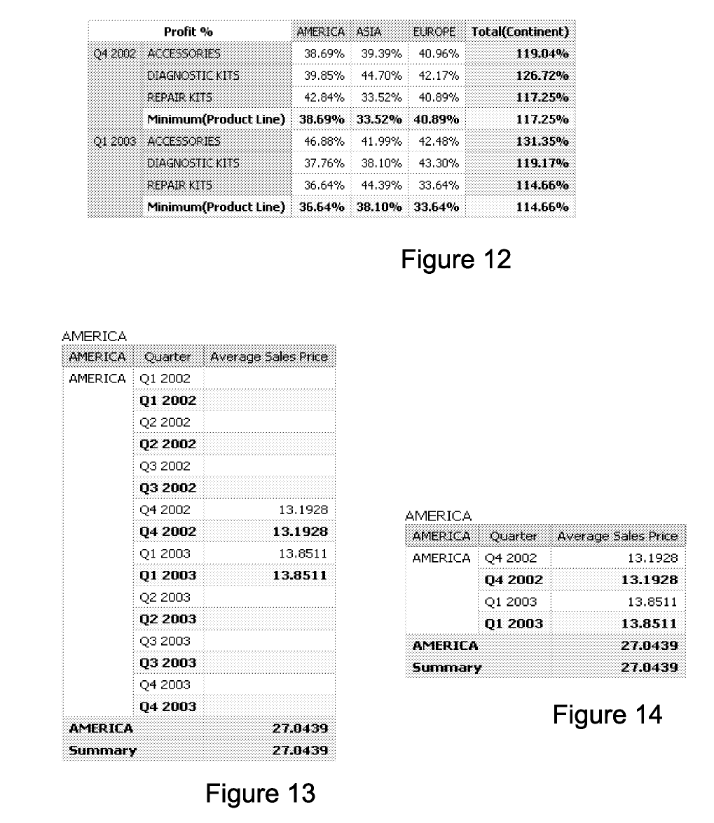

FIGS. 8-19 show examples of crosstabs and lists before and after the suppression. FIG. 7 shows an example of crosstab before the edge suppression, i.e., with the master dataset, and FIG. 8 shows its view after the edge suppression. The rows and column having no data, e.g., the row of Accessories, 100 Q3 2002, and the column of ccc have been suppressed in FIG. 8. Similarly, FIG. 9 shows another example of crosstab before the edge suppression and FIG. 10 shows its view after the edge suppression. FIG. 9 shows another example of crosstab before the edge suppression and FIG. 10 shows its view after the edge suppression. FIG. 11 shows another example of crosstab before the edge suppression and FIG. 12 shows its view after the edge suppression. In this example, no column has been suppressed

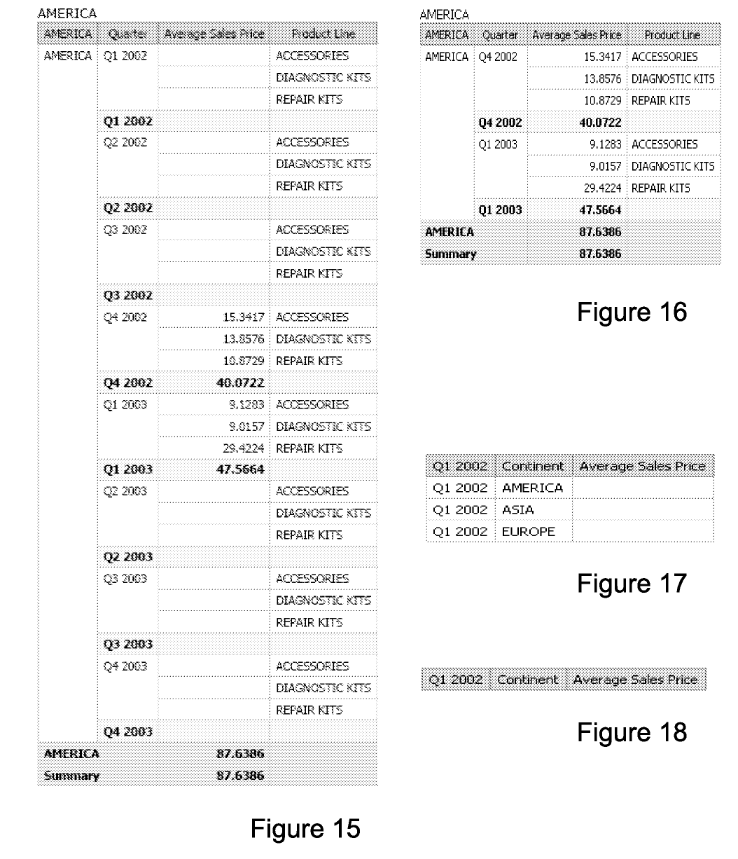

FIG. 13 shows an example of list before the edge suppression and FIG. 14 shows its view after the edge suppression. Each row having empty value and its descendant have been suppressed. FIG. 15 shows another example of list before the edge suppression and FIG. 16 shows its view after the edge suppression. FIG. 17 shows another example of list before the edge suppression and FIG. 18 shows its view after the edge suppression. In this example, all rows have been suppressed.

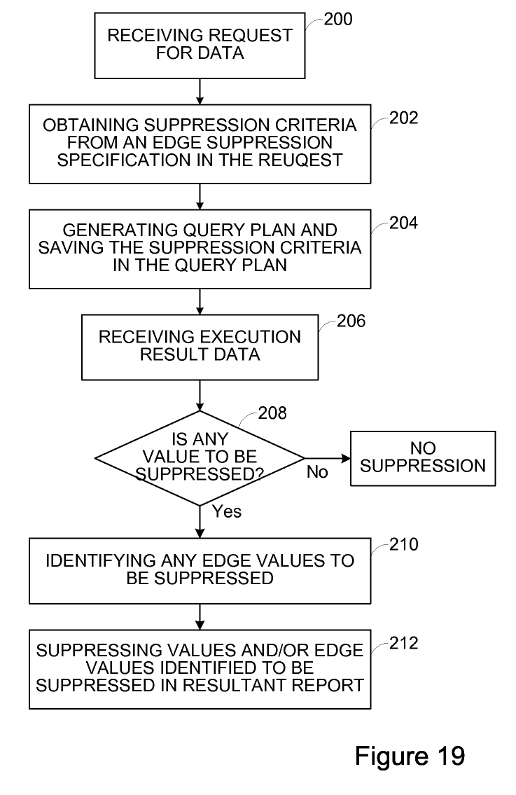

FIG. 19 shows a method of suppressing unwanted values from a report in accordance with an embodiment of the present invention. The query framework system in the report server receives a request from a client for data from one or more data sources (200), and obtains suppression criteria from an edge suppression specification in the request (202). The query framework system generates a query plan and saves the suppression criteria in the query plan (204). The query framework system receives execution result data including values (206). Each value is associated with one or more edge values. The query framework system determines if each value is to be suppressed based on the suppression criteria (208), and also identifies one or more edge values to be suppressed when an edge value has only values that are determined to be suppressed (210). The query framework system suppresses values and/or edge values identified to be suppressed in a resultant report (212).

As described above, the suppression provider 100 and the method carried out by the suppression provider 100 allow suppression of rows and/or columns in sparse BI reports, lists, crosstabs, and charts. Thus, suppression of values in sparse data can be performed using simple UI gestures. For a BI user, it is faster and more reliable to use simple UI than to edit complex filtering expression in order to solve the data scarcity problem in his report or analysis. Also, since the suppression provider is a part of the query framework system, it can handle various types of reports, e.g., crosstabs, lists and charts, without being limited to specific reports based on specific data sources.

The query framework system 10 allows for maximum flexibility for query interception, interpretation, and transformation. On the other hand, it facilitates the reuse of the functionality of components already available in the system. Thus, the query framework system 10 provides the base for pluggable component architecture; querying multidimensional, relational, and vendor query data sources; data agnostic query service: supporting same operations regardless of a data source with a consistent plug-in API; and cross-data source joins.

The integration of the suppression provider 100 within the query framework system 10 allows it to leverage the openness of the query framework system 10 to a variety of data base technologies serving a variety of BI and CPM needs.

The suppression provider of the present invention may be implemented by any hardware, software or a combination of hardware and software having the above described functions. The software code, instructions and/or statements, either in its entirety or a part thereof, may be stored in a computer readable memory. Further, a computer data signal representing the software code, instructions and/or statements may be embedded in a carrier wave may be transmitted via a communication network. Such a computer readable memory and a computer data signal and/or its carrier are also within the scope of the present invention, as well as the hardware, software and the combination thereof.

While particular embodiments of the present invention have been shown and described, changes and modifications may be made to such embodiments without departing from the scope of the invention. For example, the elements of the suppression provider are described separately, however, two or more elements may be provided as a single element, or one or more elements may be shared with other components in one or more computer systems.

What is claimed is:

1. A suppression provider for suppressing unwanted values in reports, the suppression provider comprising:
a query preparation unit analyzing a request received by a report server from a client for data from one or more underlying data sources to obtain suppression criteria from an edge suppression specification in the request, and creating a query plan and saving the suppression criteria in the query plan; and
a query execution unit receiving execution result data including values, each associated with one or more edge values, determining if each value is to be suppressed based on the suppression criteria, and identifying one or more edge values to be suppressed when an edge value has only values that are determined to be suppressed such that values and/or edge values identified to be suppressed are suppressed in a resultant report generated by the report server and returned to the client.

2. The suppression provider as claimed in claim 1, wherein
the suppression provider is part of a query framework system that converts the request from the client into a framework query using a query language specification of the query framework system, the query framework system having multiple query operation providers and a coordination planner that coordinates invocation of the query operation providers, each being capable of providing a specific query operation, the query language specification being used commonly by the query operation providers and the coordination planner, the coordination planner invoking the query operation providers in a specific sequence so that one or more of the query operation providers generate one or more provider queries, each provider query being executable by its associated query operation provider, and having the provider queries executed by the associated query operation providers to obtain data from the data sources; and
the suppression provider is a one of the query operation providers.

3. The suppression provider as claimed in claim 2, wherein the query preparation unit comprises:
an edge suppression specification analyzer analyzing the query to determine if the query has an edge suppression specification, and extracting the suppression criteria defined in the edge suppression specification; and
a query plan generator generating a provider query including a query plan of the suppression provider and storing the suppression criteria in the query plan.

4. The suppression provider as claimed in claim 3, wherein the query plan generator replaces a corresponding section of the query with the provider query.

5. The suppression provider as claimed in claim 1, wherein the query execution unit comprises:
an edge processor processing edge information;
a value analyzer analyzing values in the result data based on value suppression criteria in the suppression criteria to identify one or more cells meeting the value suppression criteria and to be suppressed, the value criteria specifying what type of values should be suppressed;
an edge mask processor determining which edge values to be processed based on edge suppression criteria in the suppression criteria, and processing mask information of each edge value to identify the edge value to be suppressed when the edge value is associated with only values that are identified to be suppressed, and
a suppression handler handling suppression of the values and/or edge values having identified to be suppressed.

6. The suppression provider as claimed in claim 5, wherein the edge processor comprises:
an original edge capturer capturing original edge information of the execution results, and storing the captured original edge information in an edge snapshot; and
an edge snapshot saving the original edge information and updating the original edge information based on the mask information.

7. The suppression provider as claimed in claim 5, wherein the value analyzer comprises:
a cell value analyzer analyzing cell values for a crosstab based on the value suppression criteria; and
an edge measure value analyzer analyzing edge measure values for a list based on the value suppression criteria.

8. The suppression provider as claimed in claim 5, wherein the edge mask processor comprises:
an edge mask constructor constructing a mask for each edge value to be processed to indicate if the corresponding edge value should be suppressed; and
a mask store storing the mask information in association with the corresponding edge value.

9. The suppression provider as claimed in claim 8, wherein the suppression handler obtains information from the mask store and updated edge information to skip the values and edges that are identified to be suppressed.

10. A method of suppressing unwanted values from a report, the method comprising:
receiving a request from a client for data from one or more data sources;
obtaining suppression criteria from an edge suppression specification in the request;
generating a query plan and saving the suppression criteria in the query plan;
receiving execution result data including values, each value being associated with one or more edge values;
determining if each value is to be suppressed based on the suppression criteria;
identifying one or more edge values to be suppressed when an edge value has only values that are determined to be suppressed; and
suppressing values and/or edge values identified to be suppressed in a resultant report returned to the client.

11. The method as claimed in claim 10, wherein
the receiving a request comprises receiving a framework query that is converted from the request from the client using a query language specification of the query framework system, the query framework system having multiple query operation providers and a coordination planner that coordinates invocation of the query operation providers, each being capable of providing a specific query operation, the query language specification being used commonly by the query operation providers and the coordination planner, the coordination planner invoking the query operation providers in a specific sequence so that one or more of the query operation providers generate one or more provider queries, each provider query being executable by its associated query operation provider, and having the provider queries executed by the associated query operation providers to obtain data from the data sources.

12. The method as claimed in claim 11, wherein the generating a query plan comprises:
analyzing the query to determine if the query has an edge suppression specification;
extracting the suppression criteria defined in the edge suppression specification; and
generating a provider query including a query plan with the suppression criteria stored in the query plan.

13. The method as claimed in claim 12, wherein the generating a query plan replaces a corresponding section of the query with the provider query.

14. The method as claimed in claim 10, wherein the determining if each value is to be suppressed comprises:
processing edge information;
analyzing values in the result data based on value suppression criteria in the suppression criteria to identify one or more cells meeting the value suppression criteria and to be suppressed, the value criteria specifying what type of values should be suppressed;
determining which edge values to be processed based on edge suppression criteria in the suppression criteria;
processing mask information of each edge value to identify the edge value to be suppressed when the edge value is associated with only values that are identified to be suppressed, and
handling suppression of the values and/or edge values having identified to be suppressed.

15. The method as claimed in claim 14, wherein the processing edge information comprises:
capturing original edge information of the execution results;
storing the captured original edge information in an edge snapshot; and
updating the edge information in the edge snapshot based on the mask information.

16. The method as claimed in claim 14, wherein the analyzing values comprises:
analyzing cell values for a crosstab based on the value suppression criteria; and
analyzing edge measure values for a list based on the value suppression criteria.

17. The method as claimed in claim 14, wherein the processing mask information comprises:
constructing a mask for each edge value to be processed to indicate if the corresponding edge value should be suppressed; and
storing the mask information in association with the corresponding edge value.

18. The method as claimed in claim 17, wherein the handling suppression comprises:
obtaining information from the mask store and updated edge information; and
skipping the values and edges that are identified to be suppressed.

19. A computer program product storing instructions or statements for use in the execution in a computer of a method of suppressing unwanted values from a report, the method comprising:
receiving a request from a client for data from one or more data sources;
obtain suppression criteria from an edge suppression specification in the request;
creating a query plan and saving the suppression criteria in the query plan;
for receiving execution result data including values, each value being associated with one or more edge values;
determining if each value is to be suppressed based on the suppression criteria;
identifying one or more edge values to be suppressed when an edge value has only values that are determined to be suppressed; and
suppressing values and/or edge values identified to be suppressed in a resultant report.

20. The computer program product as claimed in claim 19, wherein
the receiving a request comprises receiving a framework query that is converted from the request from the client using a query language specification of the query framework system, the query framework system having multiple query operation providers and a coordination planner that coordinates invocation of the query operation providers, each being capable of providing a specific query operation, the query language specification being used commonly by the query operation providers and the coordination planner, the coordination planner invoking the query operation providers in a specific sequence so that one or more of the query operation providers generate one or more provider queries, each provider query being executable by its associated query operation provider, and having the provider queries executed by the associated query operation providers to obtain data from the data sources.

21. The computer program product as claimed in claim 20, wherein the generating a query plan comprises:
analyzing the query to determine if the query has an edge suppression specification;
extracting the suppression criteria defined in the edge suppression specification; and
generating a provider query including a query plan with the suppression criteria stored in the query plan.

22. The computer program product as claimed in claim 21, wherein the generating a query plan replaces a corresponding section of the query with the provider query.

23. The computer program product as claimed in claim 19, wherein the determining if each value is to be suppressed comprises:
processing edge information;
analyzing values in the result data based on value suppression criteria in the suppression criteria to identify one or more cells meeting the value suppression criteria and to be suppressed, the value criteria specifying what type of values should be suppressed;
determining which edge values to be processed based on edge suppression criteria in the suppression criteria;
processing mask information of each edge value to identify the edge value to be suppressed when the edge value is associated with only values that are identified to be suppressed, and
handling suppression of the values and/or edge values having identified to be suppressed.

24. The computer program product as claimed in claim 23, wherein the processing edge information comprises:
capturing original edge information of the execution results;
storing the captured original edge information in an edge snapshot; and
updating the edge information in the edge snapshot based on the mask information.

25. The computer program product as claimed in claim 23, wherein the analyzing values comprises:
analyzing cell values for a crosstab based on the value suppression criteria; and
analyzing edge measure values for a list based on the value suppression criteria.

26. The computer program product as claimed in claim 23, wherein the processing mask information comprises:
constructing a mask for each edge value to be processed to indicate if the corresponding edge value should be suppressed; and
storing the mask information in association with the corresponding edge value.

27. The computer program product as claimed in claim 26, wherein the handling suppression comprises:
obtaining information from the mask store and updated edge information; and
skipping the values and edges that are identified to be suppressed.
